(19) United States
(12) Patent Application Publication
(10) Pub. No.: US 2026/0046083 A1
(43) Pub. Date: Feb. 12, 2026

(54) METHOD AND DEVICE FOR TRANSMITTING OR RECEIVING SOUNDING REFERENCE SIGNAL IN WIRELESS COMMUNICATION SYSTEM

(71) Applicant: LG ELECTRONICS INC., Seoul (KR)

(72) Inventors: Jiwon KANG, Seoul (KR); Seongwon GO, Seoul (KR)

(73) Assignee: LG ELECTRONICS INC., Seoul (KR)

(21) Appl. No.: 19/100,268

(22) PCT Filed: Aug. 7, 2023
(86) PCT No.: PCT/KR2023/011553

§ 371 Date: Jan. 31, 2025

(30) Foreign Application Priority Data
Aug. 5, 2022 (KR) 10-2022-0098103

(51) Int. Cl. H04L 5/00; H04W 72/21; H04W 72/232

(52) U.S. Cl. CPC H04L 5/0048; H04W 72/21; H04W 72/232

(57) ABSTRACT

A method according to an embodiment of the present disclosure includes reporting channel state information (CSI) and transmitting a sounding reference signal (SRS). The CSI includes at least one DL RS resource indicator. The SRS is transmitted based on at least one SRS resource. An uplink transmit (UL Tx) spatial filter related to the at least one SRS resource is determined based on the at least one DL RS resource indicator.

### TECHNICAL FIELD

The present disclosure relates to a method and a device for transmitting and receiving a sounding reference signal in a wireless communication system.

### BACKGROUND

A mobile communication system has been developed to provide a voice service while ensuring the activity of a user. However, the area of the mobile communication system has extended to a data service in addition to a voice. Due to the current explosive increase in traffic, there is a shortage of resources, and thus users demand a higher speed service. Accordingly, there is a need for a more advanced mobile communication system.

Requirements for a next-generation mobile communication system need to be able to support the accommodation of explosive data traffic, a dramatic increase in the data rate per user, the accommodation of a significant increase in the number of connected devices, very low end-to-end latency, and high-energy efficiency. To this end, various technologies, such as dual connectivity, massive multiple input multiple output (MIMO), in-band full duplex, non-orthogonal multiple access (NOMA), super wideband support, and device networking, are researched.

A study on methods to support simultaneous transmission across multiple panels (STxMP) has begun in Rel-18 MIMO. Codebook based SRS transmission (or non-codebook based SRS transmission) for each panel and beam is necessary to efficiently support STxMP PUSCH transmission.

### DISCLOSURE

### Technical Problem

According to an existing beam management method, a beam measurement and reporting (e.g., CRI/SSBRI+L1-RSRP/SINR) procedure of a UE and an SRS beam change/indication procedure for codebook/non-codebook (suitable for a beam report of the UE) should be performed to support STxMP PUSCH transmission. In this case, the following problems may occur.
[1] There are signaling overhead/latency until SRS beam change/indication.
[2] If an SRS beam for codebook/non-codebook is configured to follow a unified TCI (e.g., UL TCI or joint TCI), all beams for another UL channels/signals (e.g., PUSCH/PUCCH) (and DL channels/signals) should be changed. Therefore, there is a possibility that the STxMP beam combination is a bad beam combination in terms of UL interference. This is because it is difficult for a base station to measure UL interference for the corresponding STxMP panel/beam combination before receiving the SRS.

An object of the present disclosure is to provide a method of solving the above-described problem.

The technical objects of the present disclosure are not limited to the aforementioned technical objects, and other technical objects, which are not mentioned above, will be apparently appreciated by a person having ordinary skill in the art from the following description.

### Technical Solution

A method performed by a user equipment (UE) in a wireless communication system according to an embodiment of the present disclosure comprises reporting channel state information (CSI) and transmitting a sounding reference signal (SRS).

The CSI includes at least one DL RS resource indicator.

The SRS is transmitted based on at least one SRS resource.

An uplink transmit (UL Tx) spatial filter related to the at least one SRS resource is determined based on the at least one DL RS resource indicator.

The at least one DL RS resource indicator may be related to a simultaneous transmission based on uplink transmit (UL Tx) spatial filters by the UE.

An UL Tx spatial filter related configuration configured in the at least one SRS resource may not be used.

Based on an UL Tx spatial filter related configuration being not configured in the at least one SRS resource, the UL Tx spatial filter may be determined based on the at least one DL RS resource indicator.

The method may further comprise receiving downlink control information (DCI) including an SRS request field.

At least one aperiodic SRS resource set may be triggered based on the SRS request field.

The at least one SRS resource may be based on the at least one aperiodic SRS resource set.

The DCI may include a CSI request field.

A report of the CSI may be triggered based on the CSI request field.

The DCI may include a 1-bit field. The 1-bit field may indicate whether the at least one DL RS resource indicator is used to determine the UL Tx spatial filter.

The at least one DL RS resource indicator may be used to determine the UL Tx spatial filter is determined based on a codepoint of the SRS request field.

The method may further comprise receiving a medium access control-control element (MAC CE).

A semi-persistent SRS resource set may be activated based on the MAC CE.

The at least one SRS resource may be based on the semi-persistent SRS resource set.

The method may further comprise receiving configuration information related to the CSI.

The configuration information related to the CSI may include information related to a group based beam reporting.

The CSI may include two DL RS resource indicators related to each group of one or more groups.

The UL Tx spatial filter may include two UL Tx spatial filters determined based on two DL RS resource indicators related to a first group of the one or more groups.

The two UL Tx spatial filters may include i) a first UL Tx spatial filter determined based on a first DL RS resource indicator and ii) a second UL Tx spatial filter determined based on a second DL RS resource indicator.

A beam quality value related to the first DL RS resource indicator may be greater than a beam quality value of the second DL RS resource indicator.

The at least one SRS resource may be one SRS resource related to a plurality of antenna ports.

For at least one first antenna port of the plurality of antenna ports, the SRS may be transmitted based on the first UL Tx spatial filter.

For at least one second antenna port of the plurality of antenna ports, the SRS may be transmitted based on the second UL Tx spatial filter.

The at least one SRS resource may be a plurality of SRS resources.

For at least one first SRS resource of the plurality of SRS resources, the SRS may be transmitted based on the first UL Tx spatial filter.

For at least one second SRS resource of the plurality of SRS resources, the SRS may be transmitted based on the second UL Tx spatial filter.

The at least one first SRS resource may be based on a first SRS resource set of a plurality of SRS resource sets.

The at least one second SRS resource may be based on a second SRS resource set of the plurality of SRS resource sets.

The method may further comprise receiving configuration information related to the SRS.

The configuration information related to the SRS may include information for the plurality of SRS resource sets.

The configuration information related to the CSI may include a report quantity related to the CSI.

The report quantity may be set to i) ‘cri’-‘RSRP (Reference Signal Received Power)’, ii) ‘ssb-Index’-‘RSRP’, iii) ‘cri’-‘RSRP’-‘Index’ or iv) ‘ssb-Index’-‘RSRP’-‘Index’.

The cri may be channel state information-reference signal resource indicator (CSI-RS resource indicator, CRI), the ssb-Index may be SS/PBCH block resource indicator (SSB resource indicator, SSBRI), and the Index may be an index of a UE capability value set. A maximum supported number of SRS antenna ports may be indicated based on the index of the UE capability value set.

The CSI may further include the index of the UE capability value set.

The at least one SRS resource may be based on at least one SRS resource set.

A usage of the at least one SRS resource set may be set to a codebook, a non-codebook, an antenna switching or a beam management.

The SRS may be an aperiodic SRS or a semi-persistent SRS.

A user equipment (UE) operating in a wireless communication system according to another embodiment of the present disclosure includes one or more transceivers, one or more processors, and one or more memories operably connectable to the one or more processors and storing instructions that configure the one or more processors to perform operations based on being executed by the one or more processors.

The operations comprise reporting channel state information (CSI) and transmitting a sounding reference signal (SRS).

The CSI includes at least one DL RS resource indicator.

The SRS is transmitted based on at least one SRS resource.

An uplink transmit (UL Tx) spatial filter related to the at least one SRS resource is determined based on the at least one DL RS resource indicator.

A device according to another embodiment of the present disclosure includes one or more memories, and one or more processors operably connected to the one or more memories.

The one or more memories include instructions that configure the one or more processors to perform operations based on being executed by the one or more processors.

The operations comprise reporting channel state information (CSI) and transmitting a sounding reference signal (SRS).

The CSI includes at least one DL RS resource indicator.

The SRS is transmitted based on at least one SRS resource.

An uplink transmit (UL Tx) spatial filter related to the at least one SRS resource is determined based on the at least one DL RS resource indicator.

One or more non-transitory computer readable mediums according to another embodiment of the present disclosure stores one or more instructions.

The one or more instructions executable by one or more processors configure the one or more processors to perform operations.

The operations comprise reporting channel state information (CSI) and transmitting a sounding reference signal (SRS).

The CSI includes at least one DL RS resource indicator.

The SRS is transmitted based on at least one SRS resource.

An uplink transmit (UL Tx) spatial filter related to the at least one SRS resource is determined based on the at least one DL RS resource indicator.

A method performed by a base station in a wireless communication system according to another embodiment of the present disclosure comprises receiving channel state information (CSI) and receiving a sounding reference signal (SRS).

The CSI includes at least one DL RS resource indicator.

The SRS is received based on at least one SRS resource.

An uplink transmit (UL Tx) spatial filter related to the at least one SRS resource is determined based on the at least one DL RS resource indicator.

A base station operating in a wireless communication system according to another embodiment of the present disclosure includes one or more transceivers, one or more processors, and one or more memories operably connectable to the one or more processors and storing instructions that configure the one or more processors to perform operations based on being executed by the one or more processors.

The operations comprise receiving channel state information (CSI) and receiving a sounding reference signal (SRS).

The CSI includes at least one DL RS resource indicator.

The SRS is received based on at least one SRS resource.

An uplink transmit (UL Tx) spatial filter related to the at least one SRS resource is determined based on the at least one DL RS resource indicator.

### Advantageous Effects

According to embodiments of the present disclosure, an uplink transmit (UL Tx) spatial filter related to SRS resources is determined based on resource indicators (CRI(s) and/or SSBRI(s)) reported via CSI. Since additional signaling is not required to change beams for SRS transmission, signaling overhead/latency required to determine an optimum UL beam can be reduced compared to an existing method.

According to embodiments of the present disclosure, the resource indicators may be related to simultaneous transmission based on spatial filters by a UE. In other words, the SRS transmission may be performed based on spatial filters (e.g., corresponding to the above-described STxMP beam combination) which can be applied to the simultaneous transmission. A base station receives SRS based on the STxMP beam combination and thus can measure UL interference for each beam combination related to the simultaneous transmission. Therefore, if a unified TCI is updated based on the SRS transmission, beam combinations (e.g., combinations of the resource indicators) that greatly interfere with other UL channels/signals may be excluded.

Effects which may be obtained by the present disclosure are not limited to the aforementioned effects, and other technical effects not described above may be evidently understood by a person having ordinary skill in the art to which the present disclosure pertains from the following description.

### BRIEF DESCRIPTION OF THE DRAWINGS

FIG. 1 illustrates an example of beamforming using SSB and CSI-RS.

FIG. 2 is a flowchart showing an example of a DL BM procedure using SSB.

FIG. 3 illustrates a signaling procedure according to an embodiment of the present disclosure.

FIG. 4 is a flow chart illustrating a method performed by a user equipment according to an embodiment of the present disclosure.

FIG. 5 is a flow chart illustrating a method performed by a base station according to another embodiment of the present disclosure.

FIG. 6 illustrates configuration of a first device and a second device according to an embodiment of the present disclosure.

### DETAILED DESCRIPTION

A detailed description to be disclosed below together with the accompanying drawing is to describe exemplary embodiments of the present disclosure and not to describe a unique embodiment for carrying out the present disclosure. The detailed description below includes details to provide a complete understanding of the present disclosure. However, those skilled in the art know that the present disclosure may be carried out without the details.

In some cases, in order to prevent a concept of the present disclosure from being ambiguous, known structures and devices may be omitted or illustrated in a block diagram format based on core functions of each structure and device.

Hereinafter, downlink (DL) means communication from the base station to the terminal and uplink (UL) means communication from the terminal to the base station. In downlink, a transmitter may be part of the base station, and a receiver may be part of the terminal. In uplink, the transmitter may be part of the terminal and the receiver may be part of the terminal. The base station may be expressed as a first communication device and the terminal may be expressed as a second communication device. A base station (BS) may be replaced with terms including a fixed station, a Node B, an evolved-NodeB (eNB), a Next Generation NodeB (gNB), a base transceiver system (BTS), an access point (AP), a network (5G network), an AI system, a road side unit (RSU), a vehicle, a robot, an Unmanned Aerial Vehicle (UAV), AR (Augmented Reality) device, VR (Virtual Reality) device, and the like. Further, the terminal may be fixed or mobile and may be replaced with terms including a User Equipment (UE), a Mobile Station (MS), a user terminal (UT), a Mobile Subscriber Station (MSS), a Subscriber Station (SS), an Advanced Mobile Station (AMS), a Wireless Terminal (WT), a Machine-Type Communication (MTC) device, a Machine-to-Machine (M2M) device, and a Device-to-Device (D2D) device, the vehicle, the robot, an AI module, an Unmanned Aerial Vehicle (UAV), AR (Augmented Reality) device, VR (Virtual Reality) device, and the like.

### Beam Management (BM)

A BM procedure as layer 1 (L1)/layer 2 (L2) procedures for acquiring and maintaining a set of base station (e.g., gNB, TRP, etc.) and/or terminal (e.g., UE) beams which may be used for downlink (DL) and uplink (UL) transmission/reception may include the following procedures and terms.
Beam measurement: Operation of measuring characteristics of a beam forming signal received by the eNB or UE.
Beam determination: Operation of selecting a transmit (Tx) beam/receive (Rx) beam of the eNB or UE by the eNB or UE.
Beam sweeping: Operation of covering a spatial region using the transmit and/or receive beam for a time interval by a predetermined scheme.
Beam report: Operation in which the UE reports information of a beamformed signal based on beam measurement.

The BM procedure may be divided into (1) a DL BM procedure using a synchronization signal (SS)/physical broadcast channel (PBCH) Block or CSI-RS and (2) a UL BM procedure using a sounding reference signal (SRS).

Further, each BM procedure may include Tx beam sweeping for determining the Tx beam and Rx beam sweeping for determining the Rx beam.

### DL BM

The DL BM procedure may include (1) transmission of beamformed DL reference signals (RSS) (e.g., CIS-RS or SS Block (SSB)) of the eNB and (2) beam reporting of the UE.

Here, the beam reporting includes a preferred DL RS identifier (ID) (s) and L1-Reference Signal Received Power (RSRP) corresponding to the preferred DL RS identifier (ID) (s).

The DL RS ID may be an SSB Resource Indicator (SSBRI) or a CSI-RS Resource Indicator (CRI).

FIG. 1 illustrates an example of beamforming using SSB and CSI-RS.

As illustrated in FIG. 1, an SSB beam and a CSI-RS beam may be used for the beam management. A measurement metric is an L1-RSRP for each resource/block. The SSB may be used for coarse beam management and the CSI-RS may be used for fine beam management. The SSB may be used for both the Tx beam sweeping and the Rx beam sweeping.

The Rx beam sweeping using the SSB may be performed while the UE changes the Rx beam for the same SSBRI across multiple SSB bursts. Here, one SS burst includes one or more SSBs and one SS burst set includes one or more SSB bursts.

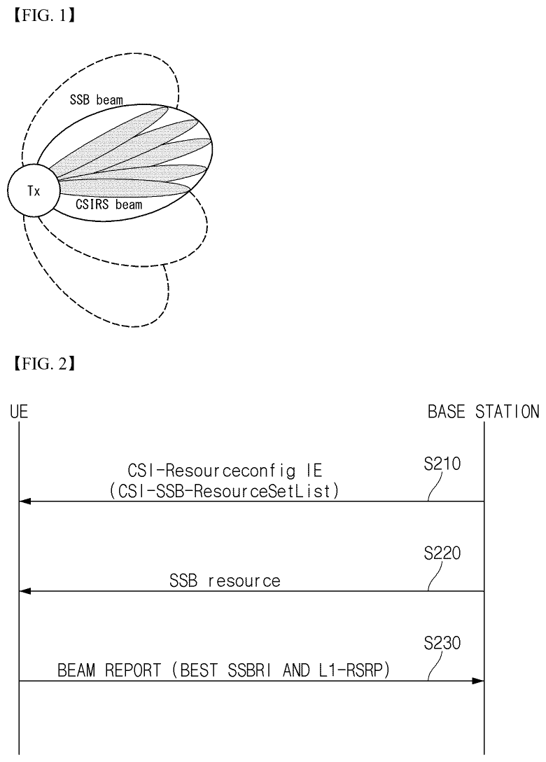

FIG. 2 is a flowchart showing an example of a DL BM procedure using SSB.

A configuration for beam report using the SSB is performed during a CSI/beam configuration in an RRC connected state (or RRC connected mode).
The UE receives from the eNB CSI-ResourceConfig IE including CSI-SSB-ResourceSetList including SSB resources used for the BM (S210).

Table 1 shows an example of CSI-ResourceConfig IE. As shown in Table 1, a BM configuration using the SSB is not separately defined and the SSB is configured like the CSI-RS resource.

TABLE 1
-- ASN1START
-- TAG-CSI-RESOURCECONFIG-START

| | |
|---|---|
| CSI-ResourceConfig ::= | SEQUENCE { |
| csi-ResourceConfigId | CSI-ResourceConfigId, |
| csi-RS-ResourceSetList | CHOICE { |
| nzp-CSI-RS-SSB | SEQUENCE { |
| nzp-CSI-RS-ResourceSetList | SEQUENCE (SIZE |

(1..maxNrofNZP-CSI-RS-ResourceSetsPerConfig)) OF NZP-CSI-RS-
ResourceSetId OPTIONAL,

| | |
|---|---|
| csi-SSB-ResourceSetList | SEQUENCE (SIZE |

```
(1..maxNrofCSI-SSB-ResourceSetsPerConfig)) OF CSI-SSB-ResourceSetId
  OPTIONAL
    },
```

| | |
|---|---|
| csi-IM-ResourceSetList | SEQUENCE (SIZE (1..maxNrofCSI- |

IM-ResourceSetsPerConfig)) OF CSI-IM-ResourceSetId
},

| | |
|---|---|
| bwp-Id | BWP-Id, |
| resourceType | ENUMERATED { aperiodic, |

semiPersistent, periodic },
...
}
-- TAG-CSI-RESOURCECONFIGTOADDMOD-STOP
-- ASN1STOP

In Table 1, csi-SSB-ResourceSetList parameter represents a list of SSB resources used for beam management and reporting in one resource set. Here, SSB resource set may be configured as {SSBx1, SSBx2, SSBx3, SSBx4, . . . }. For example, SSB index may be defined as 0 to 63.
The UE receives from the eNB the SSB resource based on the CSI-SSB-ResourceSetList (S220).
When CSI-reportConfig associated with reporting of SSBRI and L1-RSRP is configured, the UE (beam) reports to the eNB best SSBRI and L1-RSRP corresponding thereto (S230).

In other words, when reportQuantity of the CSI-reportConfig IE is configured as ‘ssb-Index-RSRP’, the UE reports to the eNB best SSBRI and L1-RSRP corresponding thereto.

In addition, when the CSI-RS resource is configured in the same OFDM symbol(s) as SSB (SS/PBCH Block) and ‘QCL-TypeD’ is applicable, the UE may assume that the CSI-RS and the SSB are quasi co-located from the viewpoint of ‘QCL-TypeD’.

Here, the QCL TypeD may mean that antenna ports are QCL from the viewpoint of a spatial Rx parameter. When the UE receives a plurality of DL antenna ports having a QCL Type D relationship, the same Rx beam may be applied. Further, the UE does not expect that the CSI-RS is configured in an RE overlapped with the RE of the SSB.

### BM Enhancements in NR Rel-16

The DL/UL beam indication standardized in 3GPP NR Rel-15 has been designed to separately indicate beams for each DL/UL channel/RS resource to ensure beam indication flexibility, and this indication method has been designed separately for each channel/RS.

This design direction eventually had the problem that a base station had to indicate a beam change for each channel/RS resource to multiple UEs communicating with the base station using a single beam in order to change a serving beam for the multiple UEs, which resulted in large signaling overhead and large beam change latency. Along with the UL beam change, UL power control-related parameters, especially pathloss RS (PL RS), had to be changed for each UL channel/RS, which also resulted in signaling overhead/latency problems. To complement these drawbacks, five features were introduced in Rel-16. Table 2 below shows the five features.

TABLE 2

| | |
|---|---|
| 1. | Default spatial relation/PL RS |

Firstly, since many UEs in NR FR2 deployment use a single analog beam at a time
and meet the beam correspondence, this enables unifying DL and UL beam
indication, meaning that a DL RS resource can be commonly used as a source RS
for both DL beam and UL beam indication. It is also possible to unify the source
DL RS for DL/UL beam indication with the pathloss reference RS, i.e. the RS used
for pathloss estimation at UE for UL power control, because gNodeB would use a
same beam direction for both transmission of the DL RS and reception of the UL
signal. Based on this motivation, the feature so called ‘default spatial
relation/pathloss reference RS’ was introduced in Rel-16. In this mode of operation,
spatial relation RS and pathloss reference RS do not need to be explicitly indicated
from gNodeB to UE, and UE uses one source RS for PDCCH/PDSCH beam as for
the spatial relation RS and the pathloss reference RS. Therefore, gNodeB only needs
to update the DL source RS whenever needed to update the serving Tx/Rx beam for
the UE. Above operation can be enabled for dedicated PUCCH, SRS, and/or
PUSCH scheduled by DCI format 0_0 by respective RRC enablers.

| | |
|---|---|
| 2. | Multi-CC simultaneous TCI/spatial relation update |

Secondly for multi-carrier operation, it is common that antenna/RF components are
shared for same or multiple bands at both gNodeB and UE sides. For example,
multi-band antenna is a very common tool for UE implementation to minimize size
and cost of the communication modules. This means that a beam can be commonly
used for transmission and/or reception across multiple component carriers (CCs) in
one or multiple bands. Based on this motivation, BM signaling can be saved via
switching beam indication from per CC basis into per CC group basis. Therefore, in
Rel-16, it was introduced that the source RS for DL/UL beam indication can be
updated simultaneously across multiple CCs. For this operation, one or two CC lists
can be configured to UE by higher layer for DL and UL, respectively. Once source
RS ID(s) are activated for DL beam indication, the RS(s) with the same RS ID(s)
are also activated in other CC(s) in the same CC list. Similarly, once a spatial
relation RS is activated for an SRS resource in a CC, the same RS is activated as
spatial relation RS for the SRS resource(s) with the same resource ID in other CC(s)
in the same CC list.

| | |
|---|---|
| 3. | PUCCH resource group based spatial relation update |

Third, in Rel. 15, the spatial relation RS for PUCCH can be activated/deactivated
per resource level. Since NR allows up to 128 PUCCH resources per UE, this per-
resource based signaling would require a large amount of beam indication signaling
for high/mid mobility UE. Due to the fact that one or a few beams are typically used.
across all PUCCH resources, e.g., one common beam per UE or per UE panel,
PUCCH resource group based spatial relation update mechanism was introduced in
Rel-16. For a UE, up to four PUCCH resource groups can be configured by RRC
per BWP, and one MAC CE can activate/deactivate a common spatial relation RS
for all the PUCCH resources in the same resource group.

| | |
|---|---|
| 4. | MAC CE based spatial relation indication for aperiodic/semi-persistent |

SRS
Fourth, SRS is an important tool for UL link adaptation and for DL channel
estimation using DL-UL channel reciprocity. In Rel.15, spatial relation RS for
aperiodic SRS was configured by RRC only, meaning that a large number of SRS
resources with different spatial relation RSs need to be configured by RRC to
support high mobility UE, for gNodeB to dynamically select and trigger one SRS
resource among them according to UE mobility. To alleviate this burden, MAC CE
based spatial relation indication for aperiodic/semi-persistent SRS was introduced
in Rel-16. Using this MAC CE, spatial relation RSs for a set of SRS resources can
be updated together.

| | |
|---|---|
| 5. | MAC CE based PL RS update for aperiodic/semi-persistent SRS and |

PUSCH
Fifth, in Rel. 15, pathloss reference RSs for UL power control for PUSCH and SRS
could only be configured by RRC and the maximum configurable number of
pathloss RSs was limited to a small number, which was four. This could lead to
frequent RRC reconfiguration considering sharply beamformed RS transmission
and high UE mobility in FR2. To address this issue, MAC CE based pathloss
reference RS update for aperiodic/semi-persistent SRS and PUSCH was introduced
in Rel-16. The maximum configurable number of pathloss reference RSs by RRC
was increased to 64, and the new MAC CE can activate up to four pathloss reference
RSs among them. Two MAC CEs were introduced for SRS and PUSCH,
respectively.

In Rel-16, enhancements related to beam reporting were made in addition to the beam/PL RS indication-related enhancements described above. In Rel-15, a mode in which a UE measures/reports L1-RSRP for each beam RS is supported. However, in an environment with high inter-beam interference, it is difficult to guarantee that a specific beam RS has good quality as a serving beam just because L1-RSRP, i.e., a reception intensity of the specific beam RS is high. In other words, the UE may select a beam, that has a high reception intensity but has high beam interference, and report the beam to a base station. To overcome this drawback, Rel-16 supports a new beam reporting mode in which the base station configures resources for interference measurement as well as RSs for channel measurement, and the UE measures L1-SINR for the channel resources and the interference resources based on this and reports several RSs with high L1-SINR value.

### BM Enhancements in NR Rel-17

As described above, various BM enhancements were made in Rel-16. In particular, the features were created that can significantly reduce the signaling overhead/latency in relation to the beam indication method. However, channel/RS-unified beams are still not configured/indicated to a UE operating with a single serving beam.

Based on this motivation, Rel-17 will standardize a channel/RS unified beam configuration/indication method. In NR, a DL beam is indicated through a transmit configuration indicator (TCI) and thus is referred to as a unified TCI state. An existing TCI state was separately configured/indicated for each DL RS/channel, but the unified TCI state is characterized by unified configuration/indication. Basically, a DL unified TCI state indicates a QCL type-D RS which is unified applied to (some) PDCCHs, PDSCH, and (some) CSI-RS resources, and an UL unified TCI state indicates a spatial relation RS (and PL RS) which is unified applied to (some) PUCCHs, PUSCH, and (some) SRSs. Since the UL spatial relation and PL RS can also be matched with the DL beam RS for a UE, for which beam correspondence is established, in the same manner as Rel-16 default spatial relation/PL RS feature, the channels/RS to which the unified TCI state is applied can encompass both DL channels/RSs and UL channels/RSs. This is referred to as a joint DL/UL TCI state. That is, the following two modes will be supported.
Joint DL/UL TCI configuration/indication mode: DL RS configured/indicated in a joint TCI state may be applied as not only the QCL type-D RSs for DL channels/RSs but also the spatial relation RSs (and PL RS) for UL channels/RSs. That is, if an update to the joint TCI state is indicated, the beam RSs (or/and PL RS) for the DL channels/RSs and the UL channels/RSs may be changed together.
Separate DL and UL TCI configuration/indication mode: QCL type-D source RSs for DL channels/RSs are unified and configured/indicated by a DL TCI state, and the spatial relation RSs (and PL RS) for UL channels/RSs are unified and configured/indicated by the UL TCI state. The DL TCI state and the UL TCI state are separately configured/indicated.

The DL/UL/joint TCI state will be indicated/updated via MAC-CE and/or DCI. More specifically, one or more TCI states of multiple TCI states configured by RRC (called a TCI state pool) are activated by MAC-CE. If the multiple TCI states are activated by MAC-CE, one of the multiple TCI states is indicated by DCI.

The DCI indication will be supported via a downlink DCI format (DCI1-1/1-2) in which a TCI field is supported, and will be supported both with PDSCH scheduling and without PDSCH scheduling. In the latter case, since the PDSCH scheduling is omitted (similar to the DCI-based semi-persistent scheduling (SPS) release method), ACK transmission of the UE for the corresponding DCI will be supported.

Enhancements related to beam report will be made in Rel-17. Rel-17 beam report mode will support a mode in which a UE measures/reports an optimal beam RS for each TRP, targeting a multi-TRP environment. To this end, if a beam measurement RS set/group is divided into two subsets/sub-groups, and the base station configures them, the UE will select RS(s) for each subset/sub-group and report them along with a quality value (L1-RSRP, [L1-SINR]) of the corresponding RS.

In the present disclosure, ‘/’ means ‘and’, ‘or’, or ‘and/or’ depending on the context.

In the present disclosure, QCL type-D RS or TCI state, or TCI for short, may mean a spatial parameter, i.e., a QCL reference RS from a beam perspective. The QCL reference RS may be extended and interpreted as a reference RS or source RS for the corresponding parameter or other beam/space related parameters.

In the present disclosure, the ‘beam’ may mean a spatial filter determined based on the reference RS or the source RS. The spatial filter may include a spatial domain filter, a spatial domain transmission filter, and a spatial domain receive filter.

For example, a beam related to UL may be referred to as i) a spatial filter (for uplink transmission or for uplink reception), ii) a spatial domain filter (for uplink transmission or for uplink reception), iii) an uplink spatial domain transmission filter, iv) an uplink spatial domain receive filter, v) an uplink transmit spatial filter (UL Tx spatial filter) or vi) an uplink receive spatial filter (UL Rx spatial filter).

For example, a beam related to DL may be referred to as i) a spatial filter (for downlink transmission or for downlink reception), ii) a spatial domain filter (for downlink transmission or for downlink reception), iii) a downlink spatial domain transmission filter, iv) a downlink spatial domain receive filter, v) a downlink transmit spatial filter (DL Tx spatial filter) or vi) a downlink receive spatial filter (DL Rx spatial filter).

For example, when beam reciprocity is established, a DL beam and an UL beam may be equally referred to as a spatial filter or a spatial domain filter. Specifically, when the beam reciprocity is established, a specific UL beam may be the same as a specific DL beam. For example, a UL beam to be used for uplink transmission of a UE may be determined based on measurement of DL beams used for transmission of a base station. For example, a DL beam to be used for downlink transmission of the base station may be determined based on measurement of UL beams used for transmission of the UE.

In an environment, such as a low-frequency band, where analog beamforming is not used, an indication of QCL type-D RS may be omitted. In this case, QCL type-D RS in the present disclosure may be interpreted as a QCL reference RS (i.e., when only one reference RS exists in the TCI state, it may refer to the corresponding RS).

From a UL perspective, a TCI state (or TCI for short) may refer to a state including a reference/source RS for a UL beam. From the UL perspective, the TCI state may indicate a spatial relation RS (and pathloss RS) in the existing Rel-15/16. Here, the pathloss RS may be configured to be the same as the corresponding RS, or to be associated with the UL TCI state or to be included separately.

Codebook (CB) or non-codebook (NCB) SRS transmission for each panel and beam is required to efficiently support STxMP PUSCH transmission. In other words, SRS transmission based on an SRS resource set, in which a usage is set to codebook or non-codebook, is required to support the STxMP PUSCH transmission.

A reason why the transmission of the SRS described above is required is as follows. When the base station pre-receives the SRS suitable for the panel and beam for STxMP PUSCH transmission, configuration for the corresponding PUSCH may be performed. The base station may transmit information including the configuration for the corresponding PUSCH to the UE. For example, the configuration for the corresponding PUSCH may include information on parameters/configuration determined by the base station receiving the SRS. For example, the configuration for the corresponding PUSCH may include transmission rank information and precoder (TPMI, SRI(s)) information for each panel and/or all the panels.

According to the existing beam management method, procedures according to the following 1) and 2) are required for configuration for the above-described PUSCH.
1. UE's beam measurement and reporting (e.g., CRI/SSBRI+L1-RSRP/SINR) procedure
2. SRS beam change/indication procedure for codebook/non-codebook (suitable for the beam report of the UE)

According to the procedures of the 1) and 2), problems according to the following [1] and [2] may occur.
[1] There are signaling overhead/latency until SRS beam change/indication.
[2] When Rel-18 unified TCI based beam changes, an SRS beam for codebook/non-codebook may be configured to follow a unified TCI (e.g., UL TCI or joint TCI). In this case, all beams for another UL channels/signals (e.g., PUSCH/PUCCH) (and DL channels/signals) should be changed for the SRS beam change. However, there is a possibility that the STxMP beam combination (combination based on the beam report of the UE) is a bad beam combination in terms of UL interference. This is because it is difficult for the base station to measure UL interference for the corresponding STxMP panel/beam combination before receiving the SRS.

Below, embodiments are described to solve/alleviate the problems (e.g., overhead, latency, unified TCI related issues) mentioned above.

### Method 1

A UE determines/applies a beam of SRS resource(s) based on reported beam RS information. In other words, an uplink transmit spatial filter(s) (UL Tx spatial filter(s)) related to the SRS resource(s) may be determined based on beam information (CRI(s)/SSBRI(s)) reported via CSI.

The SRS resource(s) may include i) aperiodic SRS resource(s) triggered based on UL DCI that triggers a beam report and/or ii) aperiodic/semi-persistent SRS resource(s) triggered by a base station after the beam report.

For example, aperiodic/semi-persistent beam report for/related to UL and/or STxMP may be triggered based on the UL DCI. That is, CSI including resource indicator(s) related to uplink and/or Simultaneous Transmission across multi panels (STxMP) may be reported based on the UL DCI.

For example, after the beam report, aperiodic SRS resource(s)/semi-persistent SRS resource(s) may be triggered/activated by DCI/MAC CE.

According to an embodiment, the beam report for the UL may be a beam report for a UE capability (set) index introduced in Rel-17 MIMO (e.g., corresponding to ‘Capability [Set] Index’ in TS38.214 V17.1.0). This is because the beam report has a feature in which the UE selects/reports CRI(s)/SSBRI(s) suitable for UL transmission. The beam report for the UE capability (set) index is described in detail below.

In Rel-17 MIMO, a beam reporting method supported in the existing release has been evolved, and thus a reporting enhancement method has been standardized to support uplink (UL) (and downlink (DL)) panel selection of the UE by reporting the UE capability (set) index corresponding to a UE panel or a panel type together and utilizing this. The UE capability (set) index may represent the maximum supported number of SRS antenna ports (e.g., 1, 2 or 4). The UE capability (set) index may be defined for panel(s) having a different number of SRS ports. The UE capability (set) index may be referred to as an index of a UE capability value set. In relation to a report quantity of the CSI, the UE capability (set) index may be referred to as ‘Capability [Set] Index’ or ‘Index’.

For example, it may be assumed that 4 panel UEs include panel #0 (2 ports), panel #1 (2 ports), panel #2 (4 ports), panel #3 (4 ports). In this instance, panel #0 and panel #1 may be mapped to Capability [Set] Index #0, and panel #2 and panel #3 may be mapped to Capability [Set] Index #1.

The CRI(s) and/or SSBRI(s) reported together with the Capability [Set] Index #0 may be related to panels (panel #0 and panel #1) having the maximum supported number of SRS ports of 2. For example, optimal panel(s) for the reported CRI(s) and/or SSBRI(s) may be the panel #0 and/or the panel #1. For example, transmission (and/or reception) based on beam(s) related to second parameters (CRI(s), SSBRI(s)) reported together with the Capability [Set] Index #0 may be performed based on the panel #0 and/or the panel #1.

Parameters (CRI(s), SSBRI(s)) reported together with the Capability [Set] Index #1 may be related to panels (panel #2 and panel #3) having the maximum supported number of SRS ports of 4. For example, optimal panel(s) for the reported CRI(s) and/or SSBRI(s) may be the panel #2 and/or the panel #3. For example, transmission (and/or reception) based on beam(s) related to the parameters (CRI(s), SSBRI(s)) reported together with the Capability [Set] Index #1 may be performed based on the panel #2 and/or the panel #3.

Based on the above-described beam report, the base station may change/indicate a best DL beam (e.g., DL TCI state) and/or a best UL beam (e.g., UL TCI state, spatial relation RS).

For example, the beam report for the UE capability (set) index may be performed based on Table 3 below.

TABLE 3

| | |
|---|---|
| 5.2.1.4.3 | L1-RSRP Reporting |

```
For L1-RSRP computation
    the UE may be configured with CSI-RS resources, SS/PBCH Block resources or both
    CSI-RS and SS/PBCH block resources, when resource-wise quasi co-located with
    ‘type C’ and ‘typeD’ when applicable.
    the UE may be configured with CSI-RS resource setting up to 16 CSI-RS resource
    sets having up to 64 resources within each set. The total number of different CSI-RS
    resources over all resource sets is no more than 128.
For L1-RSRP reporting, if the higher layer parameter nrofReportedRS in CSI-ReportConfig
is configured to be one, the reported L1-RSRP value is defined by a 7-bit value in the range
[−140, −44] dBm with 1 dB step size, if the higher layer parameter nrofReportedRS is
configured to be larger than one, or if the higher layer parameter
groupBasedBeamReporting is configured as ‘enabled’, or if the higher layer parameter
groupBasedBeamReporting-r17 is configured, the UE shall use differential L1-RSRP
based reporting, where the largest measured value of L1-RSRP is quantized to a 7-bit value
in the range [−140, −44] dBm with 1 dB step size, and the differential L1-RSRP is quantized
to a 4-bit value. The differential L1-RSRP value is computed with 2 dB step size with a
reference to the largest measured L1-RSRP value which is part of the same L1-RSRP
reporting instance. The mapping between the reported L1-RSRP value and the measured
quantity is described in [11, TS 38.133].
When the higher layer parameter groupBasedBeamReporting-r17in CSI-ReportConfig is
configured, the UE shall indicate the CSI Resource Set associated with the largest
measured value of L1-RSRP, and for each group, CRI or SSBRI of the indicated CSI
Resource Set is present first.
If the higher layer parameter timeRestrictionForChannelMeasurements in CSI-
ReportConfig is set to “notConfigured”, the UE shall derive the channel measurements for
computing L1-RSRP value reported in uplink slot n based on only the SS/PBCH or NZP
CSI-RS, no later than the CSI reference resource, (defined in TS 38.211[4]) associated with
the CSI resource setting.
If the higher layer parameter timeRestrictionForChannelMeasurements in CSI-
ReportConfig is set to “Configured”, the UE shall derive the channel measurements for
computing L1-RSRP reported in uplink slot n based on only the most recent, no later than
the CSI reference resource, occasion of SS/PBCH or NZP CSI-RS (defined in [4, TS
38.211]) associated with the CSI resource setting.
When the UE is configured with [NumberOfAdditionalPCI], a CSI-SSB-
ResourceSet configured for L1-RSRP reporting includes one or more sets of SSB
indices where PCI indices are associated with the sets of SSB indices, respectively.
When the UE is configured with a CSI-ReportConfig with the higher layer
parameter reportQuantity set to ‘cri-RSRP-Capability[Set]Index’ or ‘ssb-
Index-RSRP-Capability[Set]Index’ an index of UE capability value set,
indicating the maximum supported number of SRS antenna ports, is reported
along with the pair of SSBRI/CRI and L1-RSRP.
```

| | |
|---|---|
| 5.2.1.4.4 | L1-SINR Reporting |

```
For L1-SINR computation, for channel measurement the UE may be configured
with NZP CSI-RS resources and/or SS/PBCH Block resources, for interference
measurement the UE may be configured with NZP CSI-RS or CSI-IM resources.
    for channel measurement, the UE may be configured with CSI-RS resource
    setting with up to 16 resource sets, with a total of up to 64 CSI-RS resources
    or up to 64 SS/PBCH Block resources.
For L1-SINR reporting, if the higher layer parameter nrofReportedRS in CSI-
ReportConfig is configured to be one, the reported L1-SINR value is defined by a 7-
bit value in the range [−23, 40] dB with 0.5 dB step size, and if the higher layer
parameter nrofReportedRS is configured to be larger than one, or if the higher layer
parameter groupBasedBeamReporting is configured as ‘enabled’, the UE shall use
differential L1-SINR based reporting, where the largest measured value of L1-SINR
is quantized to a 7-bit value in the range [−23, 40] dB with 0.5 dB step size, and the
differential L1-SINR is quantized to a 4-bit value. The differential L1-SINR is
computed with 1 dB step size with a reference to the largest measured L1-SINR
value which is part of the same L1-SINR reporting instance. When NZP CSI-RS is
configured for channel measurement and/or interference measurement, the reported
L1-SINR values should not be compensated by the power offset(s) given by higher
layer parameter powerControOffsetSS or powerControlOffset.
When one or two resource settings are configured for L1-SINR measurement
    If the higher layer parameter timeRestrictionForChannelMeasurements in
    CSI-ReportConfig is set to ‘notConfigured’, the UE shall derive the channel
    measurements for computing L1-SINR reported in uplink slot n based on only
    the SSB or NZP CSI-RS, no later than the CSI reference resource, (defined in
    TS 38.211[4]) associated with the CSI resource setting.
    If the higher layer parameter timeRestrictionForChannelMeasurements in
    CSI-
  ReportConfig is set to ‘configured’, the UE shall derive the channel
    measurements for computing L1-SINR reported in uplink slot n based on only
    the most recent, no later than the CSI reference resource, occasion of SSB or
    NZP CSI-RS (defined in [4, TS 38.211]) associated with the CSI resource
    setting.
    If the higher layer parameter timeRestrictionForInterferenceMeasurements in
    CSI-ReportConfig is set to ‘notConfigured’, the UE shall derive the
    interference measurements for computing L1-SINR reported in uplink slot n
    based on only the CSI-IM or NZP CSI-RS for interference measurement
    (defined in [4, TS 38.211]) or NZP CSI-RS for channel and interference
    measurement no later than the CSI reference resource associated with the CSI
    resource setting.
    If the higher layer parameter timeRestrictionForInterferenceMeasurements in
    CSI-ReportConfig is set to ‘configured’, the UE shall derive the interference
    measurements for computing the L1-SINR reported in uplink slot n based on
    the most recent, no later than the CSI reference resource, occasion of CSI-IM
    or NZP CSI-RS for interference measurement (defined in [4, TS 38.211]) or
    NZP CSI-RS for channel and interference measurement associated with the
    CSI resource setting.
When the UE is configured a CSI-ReportConfig with the higher layer
parameter reportQuantity set to ‘cri-SINR-Capability[Set]Index’ or ‘ssb-Index-
SINR-Capability[Set]Index’ an index of UE capability value, indicating the
maximum supported number of SRS antenna ports, is reported along with the
pair of SSBRI/CRI and L1-SINR.
```

Additionally/or, the beam report for STxMP may be introduced in Rel-18 or later. For example, information on multiple CRIs/SSBRIs capable of STxMP may be reported to the base station.

The Method 1 is a method in which the UE configures/determines/applies beam(s) of CB/NCB SRS based on the UL (STxMP) beam report as described above. For this operation, beam RS information of the pre-configured/pre-indicated CB/NCB SRS (e.g., reference RS based on TCI-state or spatial relation Info configured in SRS resources) may be ignored.

Or, the beam RS may not be configured in the CB/NCB SRS resource(s) performing the corresponding operation.

The operation of the proposed method may be performed under specific conditions (e.g., the beam RS is not configured in the CB/NCB SRS) or by configuration/indication of the base station.

The configuration/indication of the base station may be performed through a message such as RRC/MAC-CE/DCI. For example, a (1 bit) indicator may be added to DCI that triggers the SRS. The indicator may represent i) whether to transmit the SRS based on the beam configured/determined through the above-described method 1 or ii) whether to transmit the SRS based on the pre-configured/pre-indicated beam.

For example, information on whether to follow the above operation (operation based on the method 1) may be added to an SRS triggering state. Specifically, codepoint(s) of the SRS triggering state representing the operation based on the method 1 may be defined/configured. The codepoint of the SRS triggering state may be based on a codepoint of an SRS request field.

For example, whether to apply the above operation (whether to apply the operation according to the method 1) may be indicated through a specific combination of a specific reserved codepoint or DCI field(s) that is not used in DCI.

According to an embodiment, among the multiple CRIs or SSBRIs reported by the UE, N (e.g., N=2) beam(s) corresponding to a highest beam quality (e.g., L1-RSRP, L1-SINR) may be applied to the SRS transmission.

According to an embodiment, among the multiple CRIs or SSBRIs reported by the UE, N beam(s) (e.g., the first N beams) selected in the order in which they are reported may be applied to the SRS transmission.

According to an embodiment, the operation according to the method 1 may be performed based on an MTRP group based beam report method introduced in Rel-17. Specifically, (two) beam RSs corresponding to the best quality or included in a first beam group may be configured/determined/applied as CB/NCB SRS beams. In this instance, a group based beam reporting may be performed based on Table 4 below. Here, the quality for the beam group may include a sum/combination of each beam quality value or defined/reported as a separate quality value.

```
TABLE 4
If the UE is configured with a CSI-ReportConfig with the higher layer parameter
reportQuantity set to ‘cri-RSRP’, ‘ssb-Index-RSRP’, ‘cri-RSRP-Capability[Set]Index’ or
‘ssb-Index-RSRP-Capability[Set]Index’,
    if the UE is configured with the higher layer parameter groupBasedBeamReporting
    set to ‘disabled’, the UE is not required to update measurements for more than 64
    CSI-RS and/or SSB resources, and the UE shall report in a single report
    nrofReportedRS (higher layer configured) different CRI or SSBRI for each report
    setting.
    if the UE is configured with the higher layer parameter groupBasedBeamReporting
    set to ‘enabled’, the UE is not required to update measurements for more than 64 CSI-
    RS and/or SSB resources, and the UE shall report in a single reporting instance two
    different CRI or SSBRI for each report setting, where CSI-RS and/or SSB resources
    can be received simultaneously by the UE either with a single spatial domain receive
    filter, or with multiple simultaneous spatial domain receive filters.
    if the UE is configured with the higher layer parameter groupBasedBeamReporting-
    r17, the UE is not required to update measurements for more than 64 CSI-RS and/or
    SSB resources, and the UE shall report in a single reporting instance
    nrofReportedRSgroup, if configured, group(s) of two CRIs or SSBRIs selecting one
    CSI-RS or SSB from each of the two CSI Resource Sets for the report setting, where
    CSI-RS and/or SSB resources of each group can be received simultaneously by the
    UE.
    if the UE is configured with the higher layer parameter groupBasedBeamReporting-
    v18 set to JointULandDL, the UE is not required to update measurements for more
    than 64 CSI-RS and/or SSB resources, and the UE shall report in a single reporting
    instance nrofReportedGroups-r18, if configured, group(s) of two CRIs or SSBRIs
    selecting one CSI-RS or SSB from each of the two CSI Resource Sets for the report
    setting, where CSI-RS and/or SSB resources of each group can be received
    simultaneously and applied for simultaneous transmission with spatial filters by the
    UE subject to UE capability.
  if the UE is configured with the higher layer parameter groupBasedBeamReporting-
    v18 set to ULOnly, the UE is not required to update measurements for more than 64
    CSI-RS and/or SSB resources, and the UE shall report in a single reporting instance
    nrofReportedGroups-r18, if configured, group(s) of two CRIs or SSBRIs selecting
    one CSI-RS or SSB from each of the two CSI Resource Sets for the report setting,
    where CSI-RS and/or SSB resources of each group can be applied for simultaneous
    transmission with spatial filters by the UE subject to UE capability.
If the UE is configured with a CSI-ReportConfig with the higher layer parameter
reportQuantity set to ‘cri-SINR’, ‘ssb-Index-SINR’, ‘cri-SINR-Capability[Set]Index’ or ‘ssb-
Index-SINR-Capability[Set]Index’,
    if the UE is configured with the higher layer parameter groupBasedBeamReporting
    set to ‘disabled’, the UE shall report in a single report nrofReportedRS (higher layer
    configured) different CRI or SSBRI for each report setting.
    if the UE is configured with the higher layer parameter groupBasedBeamReporting
    set to ‘enabled’, the UE shall report in a single reporting instance two different CRI or
    SSBRI for each report setting, where CSI-RS and/or SSB resources can be received
    simultaneously by the UE.
```

The above operation may be applied for a single SRS resource or multiple SRS resources.

According to an embodiment, the following operation may be performed on multiple antenna ports constituting a single CB SRS resource. Some port(s) may be transmitted based on beam RS #1 (e.g., CRI1 or SSBRI1), and the remaining port(s) may be transmitted based on beam RS #2 (e.g., CRI2 or SSBRI2). Here, the beam RS #1 and the beam RS #2 may correspond to STxMP capable beams. In other words, resources (CSI-RS resources and/or SSB resources) based on the beam RS #1 and the beam RS #2 may be applied to simultaneous transmission based on spatial filters by the UE.

According to an embodiment, some resource(s) with respect to multiple CB/NCB SRS resources may be transmitted based on the beam RS #1, and remaining resource(s) may be transmitted based on the beam RS #2. Here, resources applying each beam RS may construct different SRS resource set.

According to an embodiment, the same CB/NCB SRS resource/port(s) may be transmitted by applying both the beam RS #1 and the beam RS #2 (e.g., UL SFN transmission or UL (coherent) joint transmission).

In the operations according to the embodiments (e.g., in operations where ports or SRS resources are divided and applied to RS #1 and RS #2 respectively), the following embodiments may be applied.

Which beam RS should be applied to which SRS ports/resources may be configured/indicated by the base station or defined by some rule. For example, the base station may configure, to the UE, multiple CB/NCB SRS resource sets for STxMP and/or MTRP UL transmission. In this case, the following rule may be configured/defined. A first SRS resource set may be applied with a first RS (or RS with the best quality) among CRIs/SSBRIs (belonging to a specific beam RS group), and a second SRS resource set may be applied with a second RS (e.g., RS with the next best quality, RS corresponding to/in a pair relationship with/belonging to the same beam group as the first RS) among CRIs/SSBRIs (belonging to a specific beam RS group).

The above examples assume STxMP and apply two beams. However, there may be cases where the UE does not find a STxMP capable beam combination or does not prefer STxMP transmission (e.g., STxMP transmission is not preferred to reduce battery consumption). In this case, the two RSs (e.g., RS #1 and RS #2 in the above examples) may correspond to the same beam RS.

In the embodiments described above, there may be cases where the base station does not normally receive the reported CRI(s)/SSBRI(s). Or, even if the base station normally receives it, it may require time to configure/apply a receive beam for a subsequent SRS to the corresponding beam(s). Therefore, a time offset value (e.g. X symbols, Y slots, Z msecs) from a beam reporting time to time when the SRS beam(s) starts to be configured/applied to the corresponding beam(s) may be configured/specified. In this case, even if the UE receives DCI that triggers the SRS within the corresponding offset value, it may apply a beam that has been pre-configured/pre-indicated/pre-maintained without applying the reported CRI(s)/SSBRI(s).

In the present disclosure, the ‘panel’ may correspond to a ‘TRP’ that receives the corresponding signal and may correspond to a ‘beam RS (set)’, a ‘CORESET pool’, a ‘PUCCH/SRS resource group’, etc.

The above-described embodiments are described primarily on the premise that they are utilized in CB/NCB SRS. This is only for convenience of explanation and is not intended to limit the technical scope of the present disclosure to a specific usage of SRS. For example, the above-described embodiments can be applied to SRS (e.g., antenna switching, beam management) configured with other usages, in addition to the codebook/non-codebook.

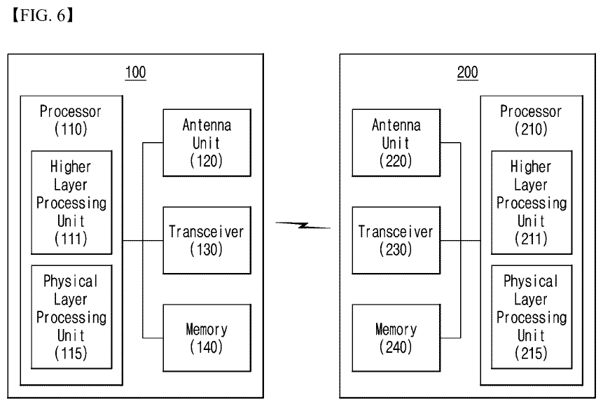

From an implementation perspective, the operations (e.g., operations based on the method 1) of the base station/UE according to the above-described embodiments may be processed by a device (e.g., 100 and 200) of FIG. 6 described below.

The operations (e.g., operations based on the method 1) of the base station/UE according to the above-described embodiments may be stored in a memory (e.g., memories 140 and 240 of FIG. 6) in the form of commands/programs (e.g., instructions, executable codes, etc.) for running at least one processor (e.g., processors 110 and 210 of FIG. 6).

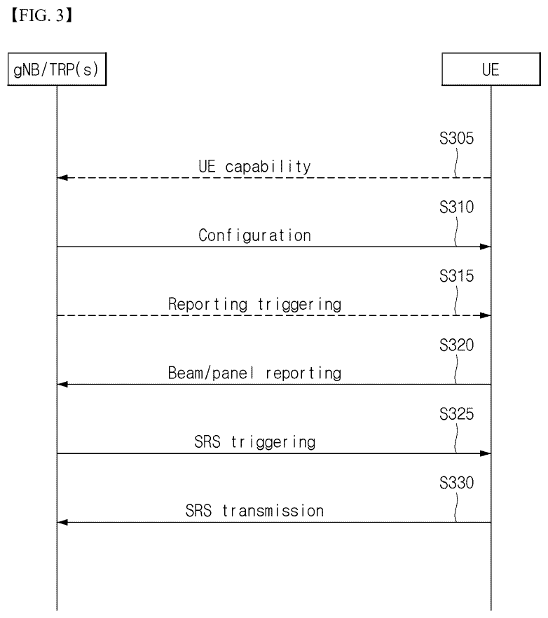

A signaling procedure based on the above-described embodiments is described in detail below with reference to FIG. 3.

FIG. 3 illustrates a signaling procedure according to an embodiment of the present disclosure.

More specifically, FIG. 3 illustrates an example of signaling between a user equipment (UE) and a base station (BS) based on the above-described proposed methods (e.g., the method 1, the method 2, the method 3). The UE/BS is merely an example and can be applied by being replaced with various devices. FIG. 3 is merely for convenience of description and does not limit the scope of the present disclosure. Further, some step(s) illustrated in FIG. 3 may be omitted depending on situation and/or setting, etc.

The UE and/or the BS in FIG. 3 may support multi-panel/TRP. The TRP/panel may be a unit including one or multiple antenna(s), antenna port(s), beam(s), and uplink/downlink RS/channel resource(s) of the UE. For example, an uplink transmission panel may be identified based on a source RS (e.g., UL TCI, spatial relation) for an uplink channel/RS, and a downlink transmission TRP may be identified based on a source RS (e.g., DL TCI, QCL RS) for a downlink channel/RS. Specifically, a unit having a specific UL/DL resource set/group (ID) or a specific (panel-related) ID as a source RS may be identified.

A UE may report UE capability information to a BS, in S305. The UE capability information may include SRS transmission related information (e.g., the maximum number of SRS resources/ports/resource sets) and STxMP related information (e.g., whether simultaneous transmission across multiple beams/resources/channels/signals is capable

The UE may receive an SRS transmission related configuration and a beam and/or panel reporting related configuration from the BS, in S310. The beam/panel reporting related configuration may include information on the number of CRI(s)/SSBRI(s) to be reported, measurement values to be reported (e.g., whether to report L1-RSRP or L1-SINR), report type information (e.g., whether it is an aperiodic report, a semi-persistent report on PUSCH, a semi-persistent report on PUCCH, or a periodic report), information related to reporting periodicity and timing (e.g., periodicity, slot offset, etc.), and an indicator for a reporting including panel (type) related information (e.g., Capability [Set] Index in TS38.214 V17.1.0). The SRS transmission related configuration may include SRS usage information, transmission periodicity, slot offset, resource information, resource set information, or the like.

After the beam/panel reporting related configuration in S310, the BS may perform a separate reporting triggering/activation indication (for semi-persistent or aperiodic report) on the UE, in S315.

The UE receiving the beam/panel reporting related configuration of S310 (and a related triggering/activation message of S315) may perform periodically/aperiodically the beam/panel related reporting based on the configuration (and a triggering/activation indication), in S320.

The base station may trigger an (aperiodic/semi-persistent) SRS based on beam/panel reporting information of the UE, in S325. The triggering message may include an indication about whether beams(s) used for the beam/panel reporting is applied to the SRS, as proposed by the present disclosure.

The UE receiving the triggering message transmits the SRS, in S330. In transmitting the SRS, the proposed technology (e.g., the Method 1) of the present disclosure may be applied. For example, SRS transmit beam(s) may be configured and transmitted based on the beam/panel reporting information of S325.

FIG. 3 illustrates the procedure in which the base station triggers the SRS after the beam/panel reporting in S325 and the UE transmits the SRS based on this in S330, by way of example. However, as described in the present disclosure, the SRS triggering step S325 may be performed together with/at the same time as the reporting triggering step S315, or performed before the beam/panel reporting step S320 of the UE after the reporting triggering step S315. In addition, the SRS transmitting step S330 may be performed together with the beam/panel reporting step S320 of the UE or performed before the beam/panel reporting step S320 of the UE.

As mentioned above, the BS/UE signaling and operation described above may be implemented by a device described below (e.g., devices 100 200 of FIG. 6). For example, the BS (e.g., TRP 1/TRP 2) may correspond to a first wireless device 100, and the UE may correspond to a second wireless device 200. In some cases, the reverse case may also be considered.

For example, the BS/UE signaling and operation described above may be processed by one or more processors (e.g., 110 and 210) of FIG. 6. The BS/UE signaling and operation described above may be stored in a memory (e.g., memories 140 and 240 of FIG. 6) in the form of a command/program (e.g., instructions, executable codes) for running at least one processor (e.g., 110 and 210) of FIG. 6.

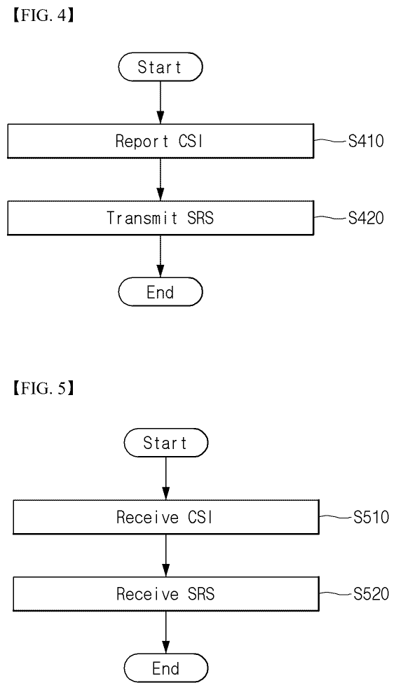

Below, the above-described embodiments are described in detail from a perspective of operations of the UE and the base station with reference to FIGS. 4 and 5. Methods described below are merely distinguished for convenience of explanation. Thus, as long as the methods are not mutually exclusive, it is obvious that partial configuration of any method can be substituted or combined with partial configuration of another method.

FIG. 4 is a flow chart illustrating a method performed by a user equipment according to an embodiment of the present disclosure.

Referring to FIG. 4, a method performed by a user equipment (UE) in a wireless communication system according to an embodiment of the present disclosure includes a CSI reporting step S410 and an SRS transmitting step S420.

In the step 410, the UE reports channel state information (CSI) to a base station.

The CSI may be reported periodically, semi-persistently or aperiodically.

The CSI may be transmitted on a physical uplink control channel (PUCCH) or a physical uplink shared channel (PUSCH).

The periodic CSI reporting is performed on a short PUCCH and a long PUCCH. The semi-persistent (SP) CSI reporting is performed on the short PUCCH, the long PUCCH, or the PUSCH. The aperiodic CSI reporting is performed on the PUSCH and is triggered by DCI. In this case, information related to the trigger of the aperiodic CSI reporting may be transmitted/indicated/configured via MAC-CE.

The CSI may include information related to a beam report (a resource indicator (at least one of CRI(s)/SSBRI(s), RSRP and/or SINR)). The present embodiment may be based on the method 1.

For example, the CSI may include at least one DL RS resource indicator. The at least one DL RS resource indicator may include i) at least one channel state information-reference signal resource indicator (CSI-RS resource syndicator, CRI) and/or ii) at least one SSB resource indicator (SS/PBCH Block (SSB) resource indicator (SSBRI)).

The at least one DL RS resource indicator (e.g., CRI/SSBRI) reported based on the CSI may be resource indicator(s) supporting Simultaneous Transmission across Multi panels (STxMP). For example, the at least one DL RS resource indicator (e.g., two CRIs or two SSBRIs) may be related to simultaneous transmission based on uplink transmit spatial filters (UL Tx spatial filters) (or spatial filters) by the UE. Specifically, resources (e.g., CSI-RS resources, SSBs) based on the at least one DL RS resource indicator (e.g., two CRIs or two SSBRIs) may be applied to the simultaneous transmission based on the spatial filters by the UE.

The method may further include a step of receiving configuration information related to the CSI. In the step, the UE may receive configuration information related to the channel state information (CSI) from the base station. The configuration information related to the CSI may include information based on the method 1 described above. The step of receiving the configuration information related to the CSI may be performed before the step S410.

The configuration information related to the CSI may include at least one of i) CSI-interference management (IM) resource related information, ii) CSI measurement configuration related information, iii) CSI resource configuration related information, iv) CSI-RS resource related information, or v) CSI report configuration related information. For example, at least one of the i) to v) may include information based on the method 1 described above.

For example, the configuration information related to the CSI may be based on the CSI report configuration related information (e.g., CSI-ReportConfig IE). The CSI report configuration related information may include information related to a group based beam reporting.

According to an embodiment, the configuration information related to the CSI may include information related to a group based beam reporting (e.g., parameter groupBasedBeamReporting).

According to an embodiment, the configuration information related to the CSI may include a report quantity related to the CSI.

For example, the report quantity may be set to 1) ‘cri’-‘RI’-‘PMI’-‘CQI’, 2) ‘cri’-‘RI’-‘i1’, 3) ‘cri’-‘RI’-‘i1’-‘CQI’, 4) ‘cri’-‘RI’-‘CQI’, 5) ‘cri’-‘RSRP’, 6) ‘ssb-Index’-‘RSRP’ 7) ‘cri’-‘RI’-‘LI’-‘PMI’-‘CQI’, 8) ‘cri’-‘SINR’, 9) ‘ssb-Index’-‘SINR’, 10) ‘cri’-‘RSRP’-‘Index’, 11) ‘ssb-Index’-‘RSRP’-‘Index’, 12) ‘cri’-‘SINR’-‘Index’ or 13) ‘ssb-Index’-‘SINR’-‘Index’.

Based on the ‘report quantity’, the CSI may include at least one of 1) Channel Quality Indicator (CQI), 2) Precoding Matrix Indicator (PMI), 3) CSI-RS Resource Indicator (CRI), 4) SSB Resource block Indicator (SSBRI), 5) Layer Indicator (LI), 6) Rank Indicator (RI), 7) Layer 1-Reference Signal Received Strength (LI-RSRP), 8) Layer 1-signal to noise and interference ratio (L1-SINR) and/or 9) CapabilityIndex or Index (an index of UE capability value set).

The CSI may include one or more parameters based on each of the 1) to 9). For example, the CSI may include one or more CRIs based on the 3). For example, the CSI may include one or more CRIs, one or more SSBRIs, and one or more indexes based on the 3), 4) and 9).

In this instance, the report quantity may be configured so that the parameter(s) related to the group based beam reporting is reported. Specifically, the report quantity may be set to i) ‘cri’-‘RSRP (Reference Signal Received Power)’, ii) ‘ssb-Index’-‘RSRP’, iii) ‘cri’-‘RSRP’-‘Index’ or iv) ‘ssb-Index’-‘RSRP’-‘Index’. The ‘cri’ is channel state information-reference signal resource indicator (CSI-RS resource indicator, CRI). The ‘ssb-Index’ is SS/PBCH block resource indicator (SSB resource indicator, SSBRI). The ‘Index’ is an index of a UE capability value set. The maximum supported number of SRS antenna ports may be indicated based on the index of the UE capability value set.

According to an embodiment, the CSI may include two DL RS resource indicators (e.g., two CRIs or two SSBRIs) related to each group of one or more groups.

In the step 420, the UE transmits a sounding reference signal (SRS) to the base station. The SRS may be transmitted based on at least one SRS resource. The SRS may be an aperiodic SRS or a semi-persistent SRS. The at least one SRS resource may be based on an aperiodic SRS resource set or a semi-persistent SRS resource set.

According to an embodiment, the at least one SRS resource may be based on at least one SRS resource set. A usage of the at least one SRS resource set may be set to codebook, non-codebook, antenna switching or beam management.

According to an embodiment, the SRS may be transmitted based on the reported beam information. Specifically, an UL Tx spatial filter related to the at least one SRS resource may be determined based on the at least one DL RS resource indicator (e.g., at least one CRI or at least one SSBRI). A reference RS for determining the UL Tx spatial filter may be based on the at least one DL RS resource indicator. The present embodiment may be based on the method 1.

The reference RS may be determined based on beam information (TCI-state/spatialRelationInfo) configured in each SRS resource. In this instance, i) if a beam (e.g., spatial filter/UL Tx spatial filter) for transmission of the SRS is determined based on the reported beam (RS) information, the beam information (e.g., UL Tx spatial filter related configuration (TCI-state/spatialRelationInfo)) configured in the SRS resource may not be utilized and may be ignored. Or ii) the corresponding operation (SRS beam determination operation) may be performed based on the beam information being not configured in the SRS resource. Embodiments related to the operation of the i) and ii) are described below.

According to an embodiment, an UL Tx spatial filter related configuration (e.g., a transmission configuration indication (TCI) state or a spatial relation configuration) configured in the at least one SRS resource may not be used (or may be ignored by the UE). The TCI state may be the above-described UL TCI state or a joint TCI state. The spatial relation configuration (e.g., a higher layer parameter spatialRelationInfo) may be related to a configuration of a spatial relation between a target SRS (i.e., the SRS) and a reference RS. That is, the UL Tx spatial filter may be determined based on at least one DL RS resource indicator (e.g., at least one CRI or at least one SSBRI) reported by the UE, regardless of the beam information configured in the at least one SRS resource (i.e., the UL Tx spatial filter related configuration (TCI state/spatialRelationInfo)).

According to an embodiment, based on an UL Tx spatial filter related configuration (e.g., a transmission configuration indication (TCI) state or a spatial relation configuration) being not configured in the at least one SRS resource, the UL Tx spatial filter may be determined based on the at least one DL RS resource indicator.

As described above, the CSI may include parameters based on a group based beam reporting (e.g., two DL RS resource indicators related to each group of one or more groups). In this case, the UL Tx spatial filter may be determined based on resource indicators based on the group based beam reporting. Embodiments related to determination of the UL Tx spatial filter are described in detail below.

According to an embodiment, the UL Tx spatial filter may include two UL Tx spatial filters determined based on two DL RS resource indicators (e.g., two CRIs or two SSBRIs) related to a first group of the one or more groups. That is, the UL Tx spatial filter may be determined based on resource indicators of a group with the best beam quality (DL RS resource indicators of the first group of the one or more groups).

According to an embodiment, the two UL Tx spatial filters may include i) a first UL Tx spatial filter determined based on a first DL RS resource indicator (e.g., first CRI or first SSBRI) and ii) a second UL Tx spatial filter determined based on a second DL RS resource indicator (e.g., second CRI or second SSBRI). A beam quality value (e.g., a first RSRP and/or a first SINR) related to the first DL RS resource indicator may be greater than a beam quality value (e.g., a second RSRP and/or a second SINR) related to the second DL RS resource indicator.

The two UL Tx spatial filters may be applied per SRS antenna port or SRS resource. This is described in detail below.

According to an embodiment, the at least one SRS resource may be one SRS resource related to a plurality of antenna ports.

For at least one first antenna port of the plurality of antenna ports, the SRS may be transmitted based on the first UL Tx spatial filter.

For at least one second antenna port of the plurality of antenna ports, the SRS may be transmitted based on the second UL Tx spatial filter.

That is, an SRS related to a first SRS antenna port (a second SRS antenna port) may be transmitted based on the first UL Tx spatial filter (the second UL Tx spatial filter).

According to an embodiment, the at least one SRS resource may be a plurality of SRS resources.

For at least one first SRS resource of the plurality of SRS resources, the SRS may be transmitted based on the first UL Tx spatial filter.

For at least one second SRS resource of the plurality of SRS resources, the SRS may be transmitted based on the second UL Tx spatial filter.

That is, in the at least one first SRS resource (second SRS resource), the SRS may be transmitted based on the first UL Tx spatial filter (the second UL Tx spatial filter).

The first/second SRS resources described above may be based on different SRS resource sets. According to an embodiment, the at least one first SRS resource may be based on a first SRS resource set of a plurality of SRS resource sets. The at least one second SRS resource may be based on a second SRS resource set of the plurality of SRS resource sets.

The method may further include a step of receiving configuration information related to the SRS. In the step of receiving the configuration information related to the SRS, the UE receives the configuration information related to the SRS from the base station. The configuration information related to the SRS may include information based on the method 1 (e.g., SRS antenna port, SRS resource set, configuration related to application of SRS beams (UL Tx spatial filter(s)) determined based on reported beam RS). The step of receiving the configuration information related to the SRS may be performed before the step S410 or the step S420.

For example, the configuration information related to the SRS may be based on SRS-Config IE of Table 5 below.

TABLE 5
-- ASN1START
-- TAG-MAC-CELL-GROUP-CONFIG-START

| | |
|---|---|
| SRS-Config ::= | SEQUENCE { |
| srs-ResourceSetToReleaseList | SEQUENCE (SIZE(1..maxNrofSRS- |
| ResourceSets)) OF SRS-ResourceSetId | OPTIONAL, -- Need N |
| srs-ResourceSetToAddModList | SEQUENCE (SIZE(1..maxNrofSRS- |
| ResourceSets)) OF SRS-ResourceSet | OPTIONAL, -- Need N |
| srs-ResourceToReleaseList | SEQUENCE (SIZE(1..maxNrofSRS- |
| Resources)) OF SRS-ResourceId | OPTIONAL, -- Need N |
| srs-ResourceToAddModList | SEQUENCE (SIZE(1..maxNrofSRS- |
| Resources)) OF SRS-Resource | OPTIONAL, -- Need N |
| tpc-Accumulation | ENUMERATED {disabled} |
| | OPTIONAL, -- Need S |

...
}

| | |
|---|---|
| SRS-ResourceSet ::= | SEQUENCE { |
| srs-ResourceSetId | SRS-ResourceSetId, |
| srs-ResourceIdList | SEQUENCE (SIZE(1..maxNrofSRS- |
| ResourcesPerSet)) OF SRS-ResourceId | OPTIONAL, -- Cond Setup |
| resourceType | CHOICE { |
| aperiodic | SEQUENCE { |
| aperiodicSRS-ResourceTrigger | INTEGER (1..maxNrofSRS- |

TriggerStates-1),

| | |
|---|---|
| csi-RS | NZP-CSI-RS-ResourceId |

OPTIONAL, -- Cond NonCodebook

| | |
|---|---|
| slotOffset | INTEGER (1..32) |

```
OPTIONAL, -- Need S
        ...,
        [[
```

| | |
|---|---|
| aperiodicSRS-ResourceTriggerList | SEQUENCE |

(SIZE(1..maxNrofSRS-TriggerStates-2))

OF INTEGER (1..maxNrofSRS-TriggerStates-

```
1) OPTIONAL -- Need M
        ]]
      },
```

| | |
|---|---|
| semi-persistent | SEQUENCE { |
| associatedCSI-RS | NZP-CSI-RS-ResourceId |

```
OPTIONAL, -- Cond NonCodebook
        ...
      },
```

| | |
|---|---|
| periodic | SEQUENCE { |
| associatedCSI-RS | NZP-CSI-RS-ResourceId |

```
OPTIONAL, -- Cond NonCodebook
        ...
      }
  },
```

| | |
|---|---|
| usage | ENUMERATED {beamManagement, codebook, |

nonCodebook, antennaSwitching},

| | |
|---|---|
| alpha | Alpha |

OPTIONAL, -- Need S

| | |
|---|---|
| p0 | INTEGER (−202..24) |

OPTIONAL, -- Cond Setup

| | |
|---|---|
| pathlossReferenceRS | PathlossReferenceRS-Config |

OPTIONAL, -- Need M

| | |
|---|---|
| srs-PowerControlAdjustmentStates | ENUMERATED { sameAsFci2, |
| separateClosedLoop} | OPTIONAL, -- Need S |

```
  ...,
  [[
```

| | |
|---|---|
| pathlossReferenceRSList-r16 | SetupRelease { PathlossReferenceRSList- |
| r16} | OPTIONAL -- Need M |

]]
}

| | |
|---|---|
| PathlossReferenceRS-Config ::= | CHOICE { |
| ssb-Index | SSB-Index, |
| csi-RS-Index | NZP-CSI-RS-ResourceId |

}

| | |
|---|---|
| SRS-PosResourceSet-r16 ::= | SEQUENCE { |
| srs-PosResourceSetId-r16 | SRS-PosResourceSetId-r16, |
| srs-PosResourceIdList-r16 | SEQUENCE (SIZE(1..maxNrofSRS- |

ResourcesPerSet)) OF SRS-PosResourceId-r16
OPTIONAL, -- Cond Setup

| | |
|---|---|
| resourceType-r16 | CHOICE { |
| aperiodic-r16 | SEQUENCE { |
| aperiodicSRS-ResourceTriggerList-r16 | SEQUENCE |

(SIZE(1..maxNrofSRS-TriggerStates-1))

OF INTEGER (1..maxNrofSRS-TriggerStates-

```
1)  OPTIONAL, -- Need M
        ...
      },
```

| | |
|---|---|
| semi-persistent-r16 | SEQUENCE { |

```
        ...
      },
```

| | |
|---|---|
| periodic-r16 | SEQUENCE { |

```
        ...
      }
  },
```

| | | |
|---|---|---|
| alpha-r16 | Alpha | OPTIONAL, |

-- Need S

| | |
|---|---|
| p0-r16 | INTEGER (−202..24) |

OPTIONAL, -- Cond Setup

| | |
|---|---|
| pathlossReferenceRS-Pos-r16 | CHOICE { |
| ssb-IndexServing-r16 | SSB-Index, |
| ssb-Ncell-r16 | SSB-InfoNcell-r16, |
| dl-PRS-r16 | DL-PRS-Info-r16 |

| | |
|---|---|
| } | OPTIONAL, -- |

Need M
...
}

| | |
|---|---|
| SRS-SpatialRelationInfo ::= | SEQUENCE { |
| servingCellId | ServCellIndex |

OPTIONAL, -- Need S

| | |
|---|---|
| referenceSignal | CHOICE { |
| ssb-Index | SSB-Index, |
| csi-RS-Index | NZP-CSI-RS-ResourceId, |
| srs | SEQUENCE { |
| resourceId | SRS-ResourceId |
| uplinkBWP | BWP-Id |

```
        }
    }
}
```

| | |
|---|---|
| SRS-SpatialRelationInfoPos-r16 ::= | CHOICE { |
| servingRS-r16 | SEQUENCE { |
| servingCellId | ServCellIndex |

OPTIONAL, -- Need S

| | |
|---|---|
| referenceSignal-r16 | CHOICE { |
| ssb-IndexServing-r16 | SSB-Index, |
| csi-RS-IndexServing-r16 | NZP-CSI-RS-ResourceId, |
| srs-SpatialRelation-r16 | SEQUENCE { |
| resourceSelection-r16 | CHOICE { |
| srs-ResourceId-r16 | SRS-ResourceId, |
| srs-PosResourceId-r16 | SRS-PosResourceId-r16 |

},

| | |
|---|---|
| uplinkBWP-r16 | BWP-Id |

```
        }
      }
  },
```

| | |
|---|---|
| ssb-Ncell-r16 | SSB-InfoNcell-r16, |
| dl-PRS-r16 | DL-PRS-Info-r16 |

}

| | |
|---|---|
| SRS-ResourceId ::= | INTEGER (0..maxNrofSRS-Resources- |

1)

Referring to Table 5 above, one or more sounding reference symbol (SRS) resource sets may be configured (via higher layer signaling, RRC signaling, etc.) by (higher layer parameter) SRS-ResourceSet. For each SRS resource set, K≥1 SRS resources (higher layer parameter SRS-resource) may be configured to the UE. Here, K is a natural number, and a maximum value of K may be indicated by SRS_capability.

The SRS-Config IE includes a list of SRS-Resources and a list of SRS-ResourceSets. Each SRS resource set means a set of SRS-resources. ‘spatialRelationInfo’ is a parameter indicating configuration of the spatial relation between the reference RS and the target SRS.

Here, the reference RS may be SSB, CSI-RS, or SRS corresponding to L1 parameter ‘SRS-SpatialRelationInfo’. ‘SRS-SpatialRelation Info’ is configured for each SRS resource and represents whether to apply the same beam as the beam used in SSB, CSI-RS, or SRS for each SRS resource.

According to an embodiment, configuration information related to the SRS may include information for the plurality of SRS resource sets (the first SRS resource set and the second SRS resource set).

The method may further include a step of receiving DCI. In the step of receiving the DCI, the UE receives downlink control information (DCI) including an SRS request field from the base station. The step of receiving the DCI may be performed before the step S410 or the step S420.

According to an embodiment, at least one aperiodic SRS resource set may be triggered based on the SRS request field. The at least one SRS resource may be based on the at least one aperiodic SRS resource set.

According to an embodiment, the DCI may be DCI (e.g., UL DCI) that triggers the beam report. Specifically, the DCI may include a CSI request field. A report of the CSI may be triggered based on the CSI request field.

According to an embodiment, whether to perform the operation of determining/transmitting the SRS beam based on the reported beam information may be determined/indicated by a 1-bit indicator or an SRS triggering state.

For example, the DCI may include a 1-bit field. The 1-bit field may indicate whether the at least one DL RS resource indicator is used to determine the UL Tx spatial filter.

For example, whether the at least one DL RS resource indicator is used to determine the UL Tx spatial filter may be determined based on a codepoint of the SRS request field.

The method may further include a step of receiving MAC CE. In the step of receiving the MAC CE, the UE receives a medium access control-control element (MAC CE) from the base station. The step of receiving the MAC CE may be performed before the step S420.

According to an embodiment, a semi-persistent (SP) SRS resource set may be activated based on the MAC CE (e.g., SP SRS Activation/Deactivation MAC CE). The at least one SRS resource may be based on the semi-persistent SRS resource set. For example, the SP SRS Activation/Deactivation MAC CE may include an SP SRS resource set ID. The SP SRS resource set ID may indicate an activated (deactivated) SP SRS resource set.

The method may further include a step of receiving a DL RS. Specifically, in the step of receiving the DL RS, the UE receives at least one downlink-reference signal (DL RS) from the base station. The step of receiving the DL RS may be performed before the step S410.

The at least one DL RS may be based on a synchronization signal/physical broadcast channel block (SS/PBCH block) (SSB) and/or channel state information-reference signal (CSI-RS).

For example, the at least one DL RS may include CSI-RSs and/or SSBs based on two CSI resource sets.

The UE may calculate the CSI (or parameter(s) included in the CSI) based on a measurement for the at least one DL RS. The parameter(s) included in the CSI may be determined/calculated based on the measurement for the at least one DL RS. The parameter(s) included in the CSI may be parameter(s) based on the ‘report quantity (reportquantity)’.

The operations based on the steps S410 and S420, the step of receiving the configuration information related to the CSI, the step of receiving the configuration information related to the SRS, the step of receiving the DCI, the step of receiving the MAC CE, and the step of receiving the DL RS described above may be implemented by a device of FIG. 6. For example, a UE 200 may control one or more transceivers 230 and/or one or more memories 240 to perform the operations based on the steps S410 and S420, the step of receiving the configuration information related to the CSI, the step of receiving the configuration information related to the SRS, the step of receiving the DCI, the step of receiving the MAC CE, and the step of receiving the DL RS.

Below, the above-described embodiments are described in detail from a perspective of base station operation.

Operations based on steps S510 and S520, a step of transmitting configuration information related to CSI, a step of transmitting configuration information related to SRS, a step of transmitting DCI, a step of transmitting MAC CE, and a step of transmitting DL RS described below correspond to the steps S410 and S420, the step of receiving the configuration information related to the CSI, the step of receiving the configuration information related to the SRS, the step of receiving the DCI, the step of receiving the MAC CE, and the step of receiving the DL RS described with reference to FIG. 4. Considering the above correspondence, redundant description is omitted. That is, the detailed description of the base station operation described below can be replaced with the description/embodiment of FIG. 4 corresponding to the base station operation.

For example, the description/embodiment of the steps S410 and S420 in FIG. 4 may be additionally applied to the base station operation of the steps S510 and S520 described below. For example, the description/embodiment of the step of receiving the configuration information related to the CSI, the step of receiving the configuration information related to the SRS, the step of receiving the DCI, the step of receiving the MAC CE, and the step of receiving the DL RS may be additionally applied to the base station operation based on the step of transmitting the configuration information related to the CSI, the step of transmitting the configuration information related to the SRS, the step of transmitting the DCI, the step of transmitting the MAC CE, and the step of transmitting the DL RS described below.

FIG. 5 is a flow chart illustrating a method performed by a base station according to another embodiment of the present disclosure.

Referring to FIG. 5, a method performed by a base station in a wireless communication system according to another embodiment of the present disclosure includes a CSI receiving step S510 and an SRS receiving step S520.

In the step 510, the base station receives channel state information (CSI) from a UE.

The method may further include a step of transmitting configuration information related to the CSI. In the step, the base station may transmit configuration information related to the channel state information (CSI) to the UE. The configuration information related to the CSI may include information based on the method 1 described above. The step of transmitting the configuration information related to the CSI may be performed before the step S510.

In the step 520, the base station receives a sounding reference signal (SRS) from the UE.

The method may further include a step of transmitting configuration information related to the SRS. In the step of transmitting the configuration information related to the SRS, the base station transmits the configuration information related to the SRS to the UE. The configuration information related to the SRS may include information based on the method 1 (e.g., SRS antenna port, SRS resource set, configuration related to application of SRS beams (UL Tx spatial filter(s)) determined based on reported beam RS). The step of transmitting the configuration information related to the SRS may be performed before the step S510 or the step S520.

The base station receives the CSI from the UE. The CSI may be calculated based on a measurement of the UE for at least one DL RS.

The method may further include a step of transmitting DCI. In the step of transmitting the DCI, the base station transmits downlink control information (DCI) including an SRS request field to the UE. The step of transmitting the DCI may be performed before the step S510 or the step S520.

The method may further include a step of transmitting MAC CE. In the step of transmitting the MAC CE, the base station transmits a medium access control-control element (MAC CE) to the UE. The step of transmitting the MAC CE may be performed before the step S520.

The method may further include a step of transmitting a DL RS. Specifically, in the step of transmitting the DL RS, the base station transmits at least one downlink-reference signal (DL RS) to the UE. The step of transmitting the DL RS may be performed before the step S510.

The operations based on the steps S510 and S520, the step of transmitting the configuration information related to the CSI, the step of transmitting the configuration information related to the SRS, the step of transmitting the DCI, the step of transmitting the MAC CE, and the step of transmitting the DL RS described above may be implemented by a device of FIG. 6. For example, a base station 100 may control one or more transceivers 130 and/or one or more memories 140 to perform the operations based on the steps S510 and S520, the step of transmitting the configuration information related to the CSI, the step of transmitting the configuration information related to the SRS, the step of transmitting the DCI, the step of transmitting the MAC CE, and the step of transmitting the DL RS.

A device to which an embodiment of the present disclosure is applicable (a device implementing the method/operation according to an embodiment of the present disclosure) is described below with reference to FIG. 6.

FIG. 6 illustrates configuration of a first device and a second device according to an embodiment of the present disclosure.

A first device 100 may include a processor 110, an antenna unit 120, a transceiver 130, and a memory 140.

The processor 110 may perform baseband-related signal processing and include a higher layer processing unit 111 and a physical layer processing unit 115. The higher layer processing unit 111 may process operations of the MAC layer, the RRC layer, or higher layers. The physical layer processing unit 115 may process the operation of the PHY layer. For example, if the first device 100 is a base station (BS) device in BS-UE communication, the physical layer processing unit 115 may perform uplink reception signal processing, downlink transmission signal processing, and the like. For example, if the first device 100 is a first UE device in inter-UE communication, the physical layer processing unit 115 may performs downlink reception signal processing, uplink transmission signal processing, sidelink transmission signal processing, and the like. The processor 110 may control the overall operation of the first device 100 in addition to performing the baseband-related signal processing.

The antenna unit 120 may include one or more physical antennas and support MIMO transmission/reception if the antenna unit 120 includes a plurality of antennas. The transceiver 130 may include a radio frequency (RF) transmitter and an RF receiver. The memory 140 may store information processed by the processor 110 and software, operating systems, and applications related to the operation of the first device 100. The memory 140 may also include components such as a buffer.

The processor 110 of the first device 100 may be configured to implement the operation of the BS in the BS-UE communication (or the operation of the first UE device in the inter-UE communication) in embodiments described in the present disclosure.

The second device 200 may include a processor 210, an antenna unit 220, a transceiver 230, and a memory 240.

The processor 210 may perform baseband-related signal processing and include a higher layer processing unit 211 and a physical layer processing unit 215. The higher layer processing unit 211 may process the operation of the MAC layer, the RRC layer, or higher layers. The physical layer processing unit 215 may process the operation of the PHY layer. For example, if the second device 200 is a UE device in BS-UE communication, the physical layer processing unit 215 may perform downlink reception signal processing, uplink transmission signal processing, and the like. For example, if the second device 200 is a second UE device in inter-UE communication, the physical layer processing unit 215 may perform downlink reception signal processing, uplink transmission signal processing, sidelink reception signal processing, and the like. The processor 210 may control the overall operation of the second device 210 in addition to performing the baseband-related signal processing.

The antenna unit 220 may include one or more physical antennas and support MIMO transmission/reception if the antenna unit 220 includes a plurality of antennas. The transceiver 230 may include an RF transmitter and an RF receiver. The memory 240 may store information processed by the processor 210 and software, operating systems, and applications related to the operation of the second device 200. The memory 240 may also include components such as a buffer.

The processor 210 of the second device 200 may be configured to implement the operation of the UE in the BS-UE communication (or the operation of the second UE device in the inter-UE communication) in embodiments described in the present disclosure.

The descriptions for the BS and the UE in the BS-UE communication (or the first UE device and the second UE device in the inter-UE communication) in the examples of the present disclosure can be equally applied to the operations of the first device 100 and the second device 200, and redundant descriptions are omitted.

The wireless communication technology implemented in the devices 100 and 200 according to the present disclosure may further include narrowband Internet of Things (NB-IoT) for low-power communication in addition to LTE, NR, and 6G. For example, the NB-IoT technology may be an example of a low power wide area network (LPWAN) technology and may be implemented in standards such as LTE Cat NB1 and/or LTE Cat NB2. The NB-IoT technology is not limited to the above-described names.

Additionally or alternatively, the wireless communication technology implemented in the devices 100 and 200 according to the present disclosure may perform communication based on LTE-M technology. For example, the LTE-M technology may be an example of the LPWAN technology, and may be called by various names such as enhanced machine type communication (eMTC). For example, the LTE-M technology may be implemented with at least one of various standards such as 1) LTE CAT 0, 2) LTE Cat M1, 3) LTE Cat M2, 4) LTE non-BL (non-Bandwidth Limited), 5) LTE-MTC, 6) LTE machine type communication, and/or 7) LTE M. The LTE-M technology is not limited to the above-mentioned names.

Additionally or alternatively, the wireless communication technology implemented in the devices 100 and 200 according to the present disclosure may include at least one of ZigBee, Bluetooth, and low power wide area network (LPWAN) in consideration of low power communication, and is not limited to the above-mentioned names. For example, the ZigBee technology may create personal area networks (PAN) related to small/low-power digital communication based on various standards such as IEEE 802.15.4, and may be called by various names.

1. A method comprising:
reporting channel state information (CSI), wherein the CSI includes at least one DL RS resource indicator; and
transmitting a sounding reference signal (SRS),
wherein the SRS is transmitted based on at least one SRS resource, and
wherein an uplink transmit (UL Tx) spatial filter related to the at least one SRS resource is determined based on the at least one DL RS resource indicator.

2. The method of claim 1, wherein the at least one DL RS resource indicator is related to a simultaneous transmission based on uplink transmit (UL Tx) spatial filters by the UE.

3-4. (canceled)

5. The method of claim 1, further comprising receiving downlink control information (DCI) including an SRS request field,
wherein at least one aperiodic SRS resource set is triggered based on the SRS request field, and
wherein the at least one SRS resource is based on the at least one aperiodic SRS resource set.

6. The method of claim 5, wherein the DCI includes a CSI request field, and
wherein a report of the CSI is triggered based on the CSI request field.

7. The method of claim 5, wherein the DCI includes a 1-bit field, and
wherein the 1-bit field indicates whether the at least one DL RS resource indicator is used to determine the UL Tx spatial filter.

8. The method of claim 5, wherein whether the at least one DL RS resource indicator is used to determine the UL Tx spatial filter is determined based on a codepoint of the SRS request field.

9. The method of claim 1, further comprising receiving a medium access control-control element (MAC CE),
wherein a semi-persistent SRS resource set is activated based on the MAC CE, and
wherein the at least one SRS resource is based on the semi-persistent SRS resource set.

10. The method of claim 1, further comprising receiving configuration information related to the CSI,
wherein the configuration information related to the CSI includes information related to a group based beam reporting.

11. The method of claim 10, wherein the CSI includes two DL RS resource indicators related to each group of one or more groups.

12. The method of claim 11, wherein the UL Tx spatial filter includes two UL Tx spatial filters determined based on two DL RS resource indicators related to a first group of the one or more groups.

13. The method of claim 12, wherein the two UL Tx spatial filters include i) a first UL Tx spatial filter determined based on a first DL RS resource indicator and ii) a second UL Tx spatial filter determined based on a second DL RS resource indicator, and
wherein a beam quality value related to the first DL RS resource indicator is greater than a beam quality value of the second DL RS resource indicator.

14. The method of claim 13, wherein the at least one SRS resource is one SRS resource related to a plurality of antenna ports,
wherein for at least one first antenna port of the plurality of antenna ports, the SRS is transmitted based on the first UL Tx spatial filter, and
wherein for at least one second antenna port of the plurality of antenna ports, the SRS is transmitted based on the second UL Tx spatial filter.

15. The method of claim 13 wherein the at least one SRS resource is a plurality of SRS resources,
wherein for at least one first SRS resource of the plurality of SRS resources, the SRS is transmitted based on the first UL Tx spatial filter, and
wherein for at least one second SRS resource of the plurality of SRS resources, the SRS is transmitted based on the second UL Tx spatial filter.

16. The method of claim 15, wherein the at least one first SRS resource is based on a first SRS resource set of a plurality of SRS resource sets, and
wherein the at least one second SRS resource is based on a second SRS resource set of the plurality of SRS resource sets.

17. The method of claim 16, further comprising receiving configuration information related to the SRS,
wherein the configuration information related to the SRS includes information for the plurality of SRS resource sets.

18. The method of claim 10, wherein the configuration information related to the CSI includes a report quantity related to the CSI, and
wherein the report quantity is set to i) ‘cri’-‘RSRP (Reference Signal Received Power)’, ii) ‘ssb-Index’-‘RSRP’, iii) ‘cri’-‘RSRP’-‘Index’ or iv) ‘ssb-Index’-‘RSRP’-‘Index’.

19. The method of claim 18, wherein the cri is channel state information-reference signal resource indicator (CSI-RS resource indicator, CRI), and the ssb-Index is SS/PBCH block resource indicator (SSB resource indicator, SSBRI),
wherein the Index is an index of a UE capability value set, and
wherein a maximum supported number of SRS antenna ports is indicated based on the index of the UE capability value set.

20. The method of claim 19, wherein the CSI further includes the index of the UE capability value set.

21-22. (canceled)

23. A user equipment comprising:
one or more transceivers;
one or more processors; and
one or more memories operably connectable to the one or more processors and storing instructions that configure the one or more processors to perform operations based on being executed by the one or more processors,
wherein the operations comprise:
reporting channel state information (CSI), wherein the CSI includes at least one DL RS resource indicator; and
transmitting a sounding reference signal (SRS),
wherein the SRS is transmitted based on at least one SRS resource, and
wherein an uplink transmit (UL Tx) spatial filter related to the at least one SRS resource is determined based on the at least one DL RS resource indicator. \

24-26. (canceled)

27. A base station comprising:
one or more transceivers;
one or more processors; and
one or more memories operably connectable to the one or more processors and storing instructions that configure the one or more processors to perform operations based on being executed by the one or more processors,
wherein the operations comprise:
receiving channel state information (CSI), wherein the CSI includes at least one DL RS resource indicator; and
receiving a sounding reference signal (SRS),
wherein the SRS is received based on at least one SRS resource, and
wherein an uplink transmit (UL Tx) spatial filter related to the at least one SRS resource is determined based on the at least one DL RS resource indicator.
